(19) United States
(12) Patent Application Publication
(10) Pub. No.: US 2024/0383315 A1
(43) Pub. Date: Nov. 21, 2024

(54) AIR-CONDITIONING REGISTER

(71) Applicant: TOYODA GOSEI CO., LTD., Kiyosu-shi (JP)

(72) Inventor: Hironori TAKAGI, Kiyosu-shi (JP)

(21) Appl. No.: 18/638,917

(22) Filed: Apr. 18, 2024

(30) Foreign Application Priority Data
May 17, 2023 (JP) 2023-081816

(51) Int. Cl. B60H 1/34

(52) U.S. Cl. CPC B60H 1/3421; B60H 2001/3471

(57) ABSTRACT

An air-conditioning register includes a retainer that forms a vent passage for air-conditioning air, multiple movable members that are attached to the retainer and movable in different directions, an actuator that rotates to actuate the movable members, and multiple conversion mechanisms that convert rotation of the actuator into motion in directions in which the movable members move, thereby actuating the movable members.

### BACKGROUND

### 1. Field

The present disclosure relates to an air-conditioning register.

### 2. Description of Related Art

Japanese Laid-Open Patent Publication No. 2017-222248 discloses an airflow direction adjusting device. The airflow direction adjusting device includes an outer case, which has an outlet that blows out air, and a rotation unit, which is accommodated in the outer case and rotates relative to the outer case.

The rotation unit includes an inner case, which includes an inner outlet for blowing out conditioned airflow, lateral louvers, which change the flow of air in the lateral direction, and vertical louvers, which change the flow of air in the vertical direction. The lateral louvers are rotatably disposed at positions in the inner case that are adjacent to the inner outlet. The vertical louvers are fixed in the inner case at positions inward of the lateral louver.

The rotation unit also includes a lateral actuation motor, which rotates the lateral louvers, and a vertical actuation motor, which rotates the rotation unit.

Such an air conditioner causes the lateral actuation motor to rotate the lateral louvers in order to laterally change the direction of airflow blown out from the outlet. Further, when the vertical actuation motor actuates the rotation unit, the inner outlet of the inner case moves vertically with respect to the outlet of the outer case. This changes the angle of the vertical louvers with respect to the outlet. That is, the airflow direction of the air blown out from the outlet is changed vertically.

Such an airflow direction adjusting device includes separate actuators such as motors for adjusting airflow direction vertically and laterally. This complicates the structure of the airflow direction adjusting device and increases its size. Such drawbacks are not limited to airflow direction adjusting devices that include multiple actuators for adjusting the airflow direction laterally and vertically. Such drawbacks are common to, for example, an airflow direction adjusting device that includes multiple actuators for actuating multiple members movable in directions different from each other.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an air-conditioning register includes a retainer that forms a vent passage for air-conditioning air, multiple movable members that are attached to the retainer and movable in different directions, an actuator that rotates to actuate the movable members, and multiple conversion mechanisms that convert rotation of the actuator into motion in directions in which the movable members move, thereby actuating the movable members.

Other features and aspects will be apparent from the following detailed description, the drawings, and the claims.

### BRIEF DESCRIPTION OF THE DRAWINGS

FIG. 1 is a plan view of an air-conditioning register according to a first embodiment.

FIG. 2 is a front view of the air-conditioning register shown in FIG. 1, mainly showing a retainer.

FIG. 3 is a cross-sectional view taken along line 3-3 in FIG. 1.

FIG. 4 is a cross-sectional view taken along line 4-4 of FIG. 3.

FIG. 5 is a plan view mainly showing a first conversion mechanism and upstream fins according to the first embodiment, illustrating a state in which a drive source gear is in a first phase.

FIG. 6 is a plan view corresponding to FIG. 5, illustrating a state in which the drive source gear is in a second phase.

FIG. 7 is a plan view corresponding to FIG. 5, illustrating a state in which the drive source gear is in a third phase.

FIG. 8 is a plan view mainly showing the drive source gear, a second conversion mechanism, and a slide cover according to the first embodiment, illustrating a state in which the drive source gear is in the first phase.

FIG. 9 is a plan view corresponding to FIG. 8, illustrating a state in which the drive source gear is in the second phase.

FIG. 10 is a plan view corresponding to FIG. 8, illustrating a state in which the drive source gear is in the third phase.

FIG. 11 is a plan view of an air-conditioning register according to a second embodiment.

FIG. 12 is a side view of a second conversion mechanism according to the second embodiment, mainly showing a rotation plane conversion mechanism and a downstream fin actuation mechanism.

FIG. 13 is a diagram mainly showing drive gears and a coupling portion in the downstream fin actuation mechanism shown in FIG. 12.

FIG. 14 is a diagram mainly showing the drive gears and the coupling portion in the downstream fin actuation mechanism shown in FIG. 12.

FIG. 15 is a plan view mainly showing a first conversion mechanism and upstream fins of the second embodiment.

FIG. 16 is a diagram illustrating a state in which the upstream fins have been rotated from the state shown in FIG. 15.

FIG. 17 is a plan view of the second conversion mechanism according to the second embodiment, showing a state in which an intermediate gear and a driven gear mesh with each other.

FIG. 18 is a plan view mainly showing the rotation plane conversion mechanism and the downstream fin actuation mechanism, illustrating a state in which the rotation plane conversion mechanism has been rotated from the state shown in FIG. 11.

FIG. 19 is a side view illustrating the rotation plane conversion mechanism and the downstream fin actuation mechanism shown in FIG. 18.

FIG. 20 is a cross-sectional view showing a state of the downstream fins when the airflow direction of air-conditioning air has been changed from the state shown in FIG. 3.

FIG. 21 is a diagram illustrating a state in which the rotational surface conversion mechanism has been rotated in a direction opposite to that in FIG. 18 from the state shown in FIG. 11.

FIG. 22 is a side view mainly showing the rotation plane conversion mechanism and the downstream fin actuation mechanism shown in FIG. 21.

FIG. 23 is a cross-sectional view showing a state of the downstream fins when the airflow direction of air-conditioning air has been changed from the state shown in FIG. 3.

FIG. 24 is a diagram of an operation of the air-conditioning register according to the second embodiment, illustrating one example of a trajectory of a spot through which the airflow of the air-conditioning air passes.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, except for operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

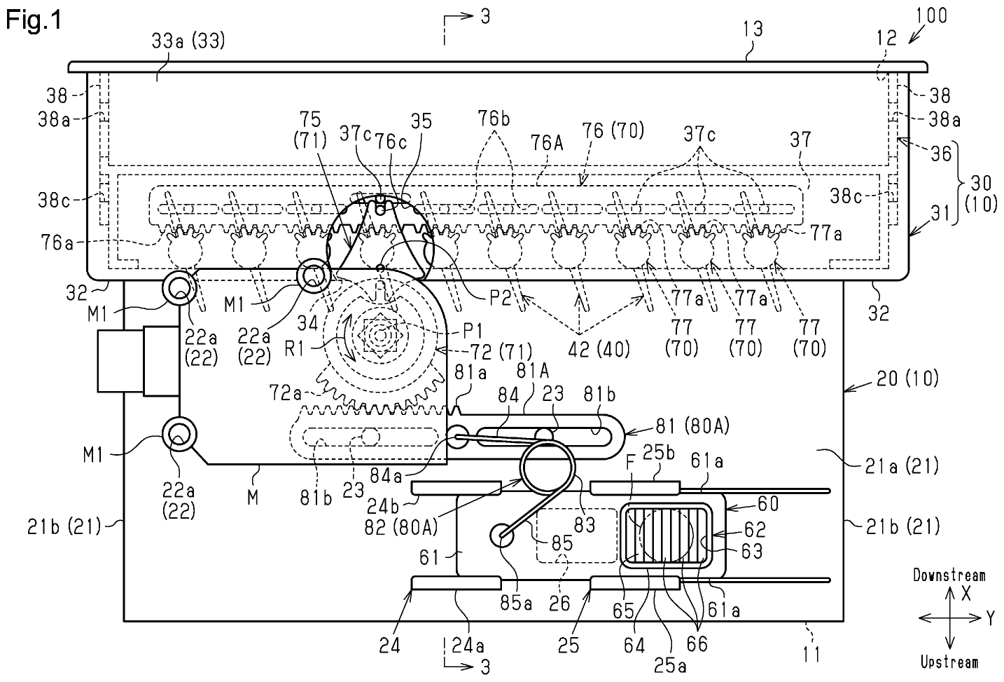

An air-conditioning register 100 according to a first embodiment will now be described with reference to FIGS. 1 to 10. In the present embodiment, the present disclosure is implemented as the air-conditioning register 100 for a vehicle that is provided in an instrument panel of an automobile and changes the airflow direction of air-conditioning air A flowing to the passenger compartment from an air conditioner.

### Basic Configuration of Air-Conditioning Register 100

As shown in FIGS. 1 to 4, the air-conditioning register 100 includes a tubular retainer 10, which forms a passage for the air-conditioning air A (hereinafter, referred to as a vent passage 10A).

In the following description, the direction in which the air-conditioning air A flows through the vent passage 10A will be referred to as a flow direction X, and an upstream side and a downstream side in the flow direction X will simply be referred to as an upstream side and a downstream side. In the thickness direction of the retainer 10, the direction toward the vent passage 10A will be referred to as an inner side, and the direction away from the vent passage 10A will be referred to as an outer side.

The air-conditioning register 100 includes upstream fins 40, downstream fins 50, a slide cover 60, a motor M, a first conversion mechanism 70, and a restriction mechanism 80A. The upstream fins 40 and the downstream fins 50 are provided in the vent passage 10A. The slide cover 60, the motor M, the first conversion mechanism 70, and the restriction mechanism 80A are all attached to the outer side of the retainer 10.

In the first embodiment, the upstream fins 40 and the slide cover 60 correspond to the movable members according to the present disclosure. The motor M rotates to actuate the movable members of the present disclosure and corresponds to the actuator according to the present disclosure.

Each component will now be described.

### Retainer 10

As shown in FIGS. 1 to 4, the retainer 10 includes an upstream opening 11, which is located at the upstream end of the vent passage 10A, and a downstream opening 12, which is located at the downstream end of the vent passage 10A.

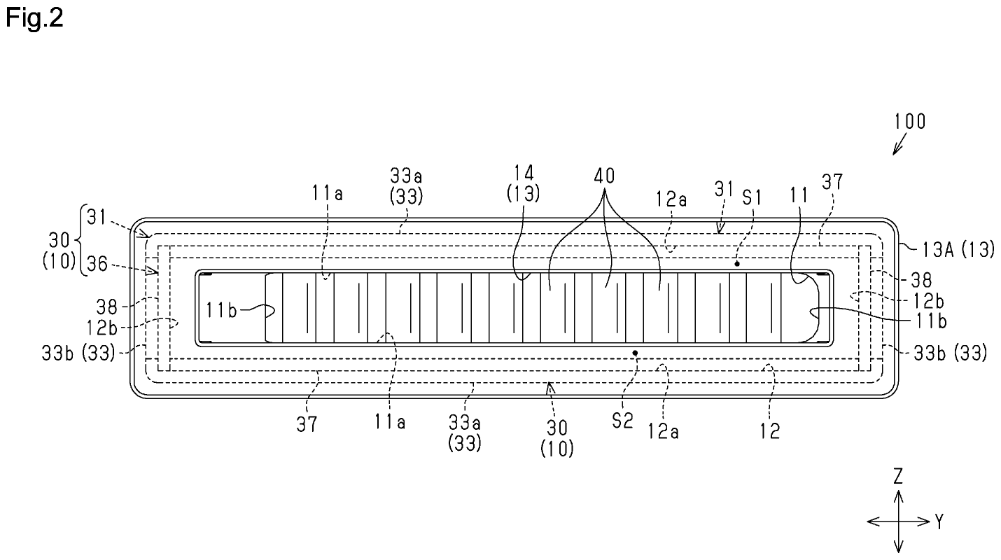

As shown in FIG. 2, the upstream opening 11 and the downstream opening 12 have rectangular shapes as viewed from the front. Specifically, the upstream opening 11 has a rectangular shape with rounded corners. In the following description, a direction in which the two short sides 12b (11b) of the opening 12 (11) are arranged will be referred to as a longitudinal direction Y, and a direction in which the two long sides 12a (11a) are arranged will be referred to as a traverse direction Z.

As shown in FIG. 2, the dimension of the downstream opening 12 is larger than the dimension of the upstream opening 11 in both the flow direction X and the longitudinal direction Y.

As shown in FIGS. 1 to 4, the retainer 10 includes an upstream retainer member 20, which has the upstream opening 11, a downstream retainer member 30, which has the downstream opening 12, and a bezel 13, which is attached to the downstream opening 12.

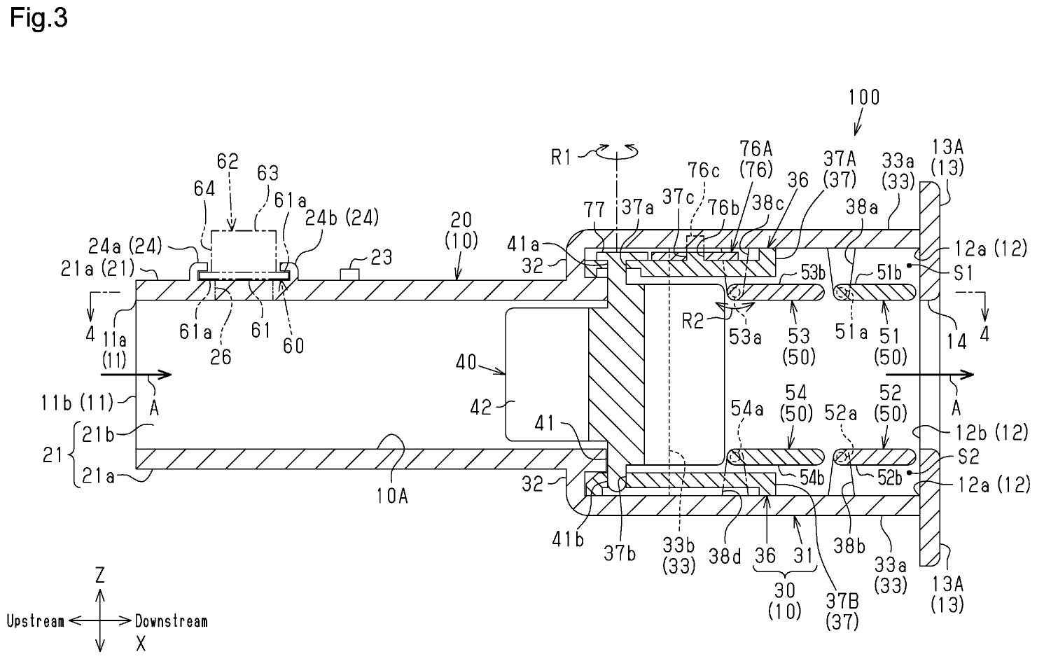

As shown in FIGS. 2 and 3, the bezel 13 is a flat plate that is shaped as a rectangle with rounded corners as a whole. The bezel 13 includes a main body 13A, which extends along the downstream opening 12, and a bezel opening 14, which is surrounded by the main body 13A. The surface on the downstream side of the main body 13A forms a decorative surface of the register 100. The bezel opening 14 is continuous with the downstream opening 12 and forms an outlet for the air-conditioning air A in the register 100. In the present embodiment, the dimension of the bezel opening 14 is smaller than the dimension of the downstream opening 12 in both the longitudinal direction Y and the traverse direction Z.

### Upstream Retainer Member 20

As shown in FIG. 3, the upstream retainer member 20 includes an upstream peripheral wall 21, which forms the upstream opening 11.

The upstream peripheral wall 21 includes two first wall portions 21a, which form the two long sides 11a of the upstream opening 11, and two second wall portions 21b, which form the two short sides 11b.

As shown in FIGS. 1 and 3, one of the two first wall portions 21a located on a first side in the traverse direction Z (upper side in the vertical direction in FIG. 3) includes mounting portions 22, second guide projections 23, a first guide track 24, a second guide track 25, and a through-hole 26.

The mounting portions 22 are used to mount the motor M. For example, screws (not shown) are screwed into threaded hole 22a of the mounting portions 22 and fastening holes M1 of the motor M to fix the motor M to the mounting portions 22. In the present embodiment, the first wall portion 21a has three mounting portions 22.

The second guide projections 23 are configured to support a second rack 81, which will be discussed below, and project from the first wall portion 21a toward the first side in the traverse direction Z (upward as viewed in FIG. 3). The present embodiment includes two second guide projections 23 spaced apart from each other in the longitudinal direction Y (refer to FIG. 1). In the present embodiment, the two second guide projections 23 are arranged at the center of the first wall portion 21a in both the longitudinal direction Y and the traverse direction Z.

As shown in FIGS. 1 and 3, the first guide track 24 includes an upstream rail 24a and a downstream rail 24b, which are spaced apart from each other in the flow direction X.

The upstream rail 24a protrudes from the first wall portion 21a toward the first side in the traverse direction Z (upward as viewed in FIG. 3) and is bent toward the downstream side.

The downstream rail 24b protrudes from the first wall portion 21a toward the first side in the traverse direction Z (upward as viewed in FIG. 3) and is bent toward the upstream side.

The upstream rail 24a and the downstream rail 24b extend in the longitudinal direction Y.

As shown in FIG. 1, the second guide track 25 includes an upstream rail 25a and a downstream rail 25b, and have the same structure as the first guide track 24.

The first guide track 24 and the second guide track 25 are spaced apart from each other in the longitudinal direction Y. Further, the first guide track 24 and the second guide track 25 are located upstream of the two second guide projections 23. In the present embodiment, the first guide track 24 is located between the two second guide projections 23 in the longitudinal direction Y. The second guide track 25 is located closer to the first side in the longitudinal direction Y (right side in the lateral direction in FIG. 1) than the two second guide projections 23 are.

As shown in FIGS. 1 and 3, the through-hole 26 is a hole that extends in the traverse direction Z from the outer surface of the first wall portion 21a to the vent passage 10A.

The through-hole 26 is located between the upstream rails 24a, 25a and the downstream rails 24b, 25b in the flow direction X, and between the first guide track 24 and the second guide track 25 in the longitudinal direction Y (refer to FIG. 1).

### Downstream Retainer Member 30

As shown in FIGS. 1 to 4, the downstream retainer member 30 includes an outer retainer portion 31, which is connected to the downstream end of the upstream retainer member 20, and an inner retainer portion 36, which is arranged inside the outer retainer portion 31.

The outer retainer portion 31 includes a coupling wall 32 and a downstream peripheral wall 33. The coupling wall 32 protrudes from the outer surface on the downstream side of the upstream retainer member 20. The downstream peripheral wall 33 is bent and extends from the coupling wall 32 and forms a part of the downstream opening 12.

The coupling wall 32 is provided over the entire circumference of the upstream peripheral wall 21.

The downstream peripheral wall 33 includes two first outer wall portions 33a, which are arranged in the traverse direction Z, and two second outer wall portions 33b, which are arranged in the longitudinal direction Y. The first outer wall portions 33a extend further downstream than the two second outer wall portions 33b, and form the two long sides 12a of the downstream opening 12.

As shown in FIG. 3, the two first outer wall portions 33a, together with the coupling wall 32 and the main body 13A of the bezel 13, define spaces S1, S2 in the downstream retainer member 30.

As shown in FIG. 2, the register 100 is configured such that the inside of the spaces S1, S2 is concealed by the main body 13A of the bezel 13 in front view.

As shown in FIG. 1, one of the two first outer wall portions 33a (the front side in the direction orthogonal to the sheet of FIG. 1) includes an opening portion 35 that extends through the first outer wall portion 33a in the traverse direction Z and is continuous with a cutout portions 34 of the coupling wall 32.

As shown in FIGS. 1 to 4, the inner retainer portion 36 includes two first inner wall portions 37, which are arranged in the traverse direction Z, and two second inner wall portions 38, which are arranged in the longitudinal direction Y and form the two short sides 12b of the downstream opening 12.

As shown in FIGS. 1 and 3, the two first inner wall portions 37 are rectangular flat plates elongated in the longitudinal direction Y and are arranged in the space S1 and the space S2 (refer to FIG. 3). The two first inner wall portions 37 each include two ends in the longitudinal direction Y that are coupled to the second inner wall portion 38 (refer to FIG. 1).

As shown in FIGS. 1 and 3, the first inner wall portion 37A, which is arranged in the space S1, includes pivot holes 37a and first guide projections 37c.

The pivot holes 37a extend through the first inner wall portion 37A in the traverse direction Z. In the present embodiment, ten pivot holes 37a are arranged at equal intervals in the longitudinal direction Y.

As shown in FIG. 3, the first inner wall portion 37B, which is arranged in the compartment S2, includes pivot holes 37b. The pivot holes 37b are aligned with the pivot holes 37a on the same axis extending in the traverse direction Z.

The first guide projections 37c protrude toward the first side in the traverse direction Z (upward as viewed in FIG. 3) on the downstream side of the pivot holes 37a. In the present embodiment, ten first guide projections 37c are arranged in the longitudinal direction Y while being spaced apart from each other.

As shown in FIG. 1, one of the first guide projections 37c that is located at the position corresponding to the opening portion 35 is located on the downstream side of the other first guide projections 37c.

As shown in FIGS. 1 and 3, the second inner wall portion 38 includes two first cutout portions 38a, 38b and two second cutout portions 38c, 38d, which are cut out in the traverse direction Z from the opposite edges in the traverse direction Z, respectively.

The second cutout portions 38c, 38d are located on the upstream side of the two first cutout portions 38a, 38b.

### Upstream Fins 40

As shown in FIGS. 1 and 3, each upstream fin 40 includes a first fin pivot 41, which extends in the traverse direction Z, and a fin body 42, which is integrated with the first fin pivot 41 and has the shape of a flat plate.

As shown in FIG. 3, a first end 41a of the first fin pivot 41 is inserted into the pivot hole 37a of the first inner wall portion 37A. A second end 41b of the first fin pivot 41 is inserted into the pivot hole 37b of the first inner wall portion 37B. Thus, the upstream fin 40 is supported to be rotatable about the first fin pivots 41 in a rotation direction R1 in the vent passage 10A. In the present embodiment, the rotation direction R1 corresponds to the first direction according to the present disclosure.

As shown in FIG. 1, in the present embodiment, ten upstream fins 40 are arranged at equal intervals in the longitudinal direction Y. Specifically, the fin bodies 42 of the ten upstream fins 40 are arranged in a state of extending parallel with each other. In the present embodiment, the longitudinal direction Y corresponds to the arrangement direction of the fins according to the present disclosure.

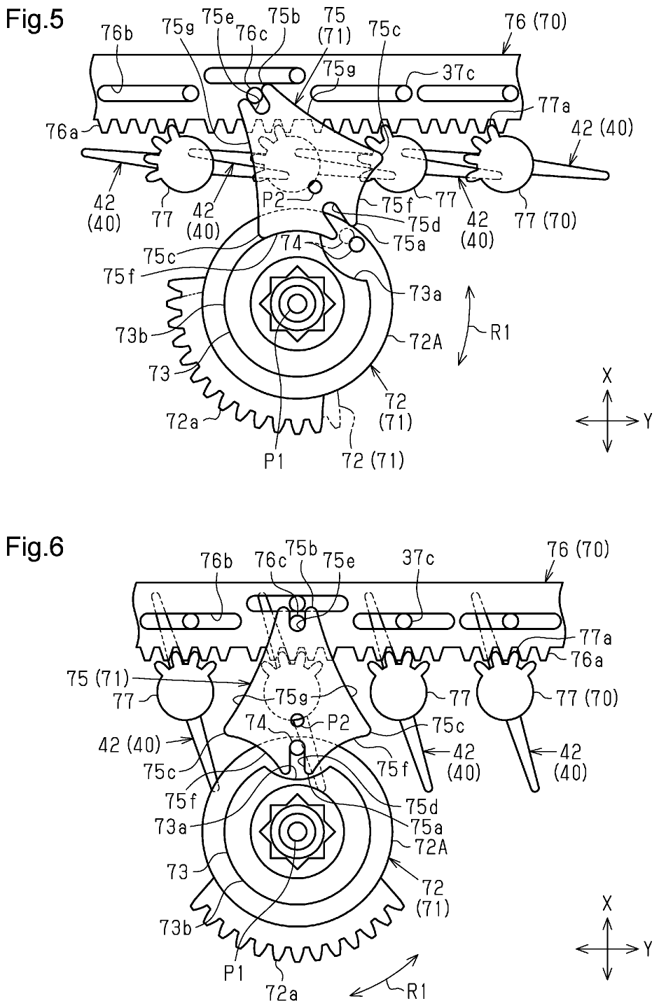

As shown in FIG. 5, in the rotation direction R1, the position at which the upstream fins 40 have rotated until the fin bodies 42 of the upstream fins 40 adjacent to each other in the longitudinal direction Y contact and overlap with each other is defined as a fin-shut position of the upstream fins 40.

### Downstream Fins 50

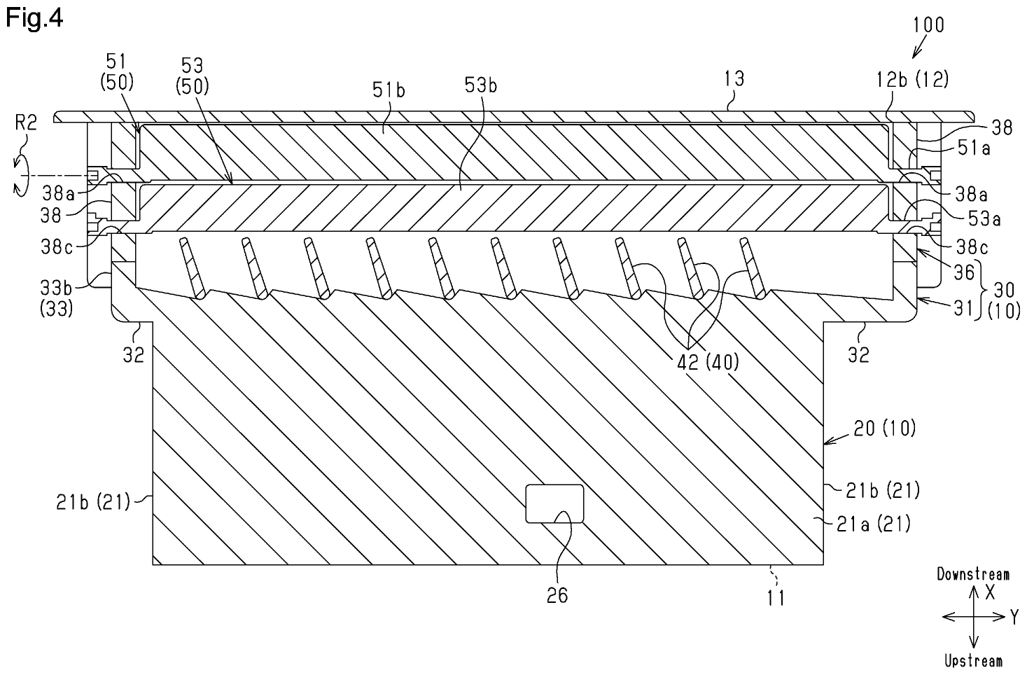

As shown in FIGS. 3 and 4, the downstream fins 50 are arranged on the downstream side of the upstream fins 40 in the vent passage 10A.

The downstream fins 50 include two first downstream fins 51, 52 and two second downstream fins 53, 54.

The first downstream fins 51, 52 have second fin pivots 51a, 52a, which extend in the longitudinal direction Y, and plate-shaped fin bodies 51b, 52b, which extend downstream from the second fin pivots 51a, 52a.

The opposite ends of the second fin pivot 51a are respectively inserted into the first cutout portions 38a formed in the two second inner wall portions 38. Thus, the first downstream fin 51 is supported to be rotatable about the second fin pivot 51a in a rotation direction R2 in the vent passage 10A.

The opposite ends of the second fin pivot 52a are respectively inserted into the first cutout portions 38b formed in the two second inner wall portions 38. Thus, the first downstream fin 52 is supported to be rotatable about the second fin pivot 51a in the rotation direction R2 in the vent passage 10A.

As shown in FIG. 4, the fin body 51b and the fin body 52b have the same shape and are each rectangular and elongated in the longitudinal direction Y.

As shown in FIG. 3, the first downstream fins 51, 52 are arranged to face each other in the traverse direction Z.

As shown in FIGS. 3 and 4, the second downstream fins 53, 54 have second fin pivots 53a, 54a, which extend in the longitudinal direction Y, and plate-shaped fin bodies 53b, 54b, which extend downstream from the second fin pivots 53a, 54a.

The opposite ends of the second fin pivot 53a are respectively inserted into the second cutout portions 38c formed in the two second inner wall portions 38. Thus, the second downstream fin 53 is supported to be rotatable about the second fin pivot 53a in the rotation direction R2 in the vent passage 10A.

The opposite ends of the second fin pivot 54a are respectively inserted into the second cutout portions 38d formed in the two second inner wall portions 38. Thus, the second downstream fin 54 is supported to be rotatable about the second fin pivot 54a in the rotation direction R2 in the vent passage 10A.

As shown in FIG. 4, the fin body 53b and the fin body 54b have the same shape and are each rectangular and elongated in the longitudinal direction Y.

As shown in FIG. 3, the second downstream fins 53, 54 are arranged to face each other in the traverse direction Z.

The second downstream fin 53 is arranged on the upstream side of the first downstream fin 51. Also, the second downstream fin 54 is arranged on the upstream side of the first downstream fin 52.

The first downstream fin 51 and the second downstream fin 53 are accommodated in the space S1 of the downstream retainer member 30. Also, the first downstream fin 52 and the second downstream fin 54 are accommodated in the space S2 of the downstream retainer member 30.

### Slide Cover 60

As shown in FIGS. 1 and 3, the slide cover 60 includes a flat plate-shaped cover body 61 and an accommodating portion 62, which projects from the cover body 61.

The cover body 61 is rectangular in plan view and extends in the longitudinal direction Y (refer to FIG. 1).

The cover body 61 includes edges 61a at the opposite ends in the flow direction X. The edges 61a are respectively inserted into the gap between the first guide track 24 and the first wall portion 21a and between the second guide track 25 and the first wall portion 21a. Accordingly, the slide cover 60 is supported to be slidable in the longitudinal direction Y with respect to the upstream retainer member 20. In the first embodiment, the longitudinal direction Y corresponds to the second direction according to the present disclosure.

As shown in FIGS. 1 and 3, the accommodating portion 62 is configured to accommodate an air freshener F, which is a chemical agent, and has the shape of a box as a whole with an opening portion 63 on a first side in the traverse direction Z (the upper side as viewed in FIG. 3).

The accommodating portion 62 includes an upright wall portion 64, which forms the opening portion 63, and a bottom wall 65, which is opposed to the opening portion 63.

The upright wall portion 64 is configured to allow the air freshener F to be placed in and removed from the accommodating portion 62 through the opening portion 63.

As shown in FIG. 1, the bottom wall 65 has a grid-like structure and includes gaps 66, which extend in the flow direction X and are arranged at equal intervals in the longitudinal direction Y. The width of each gap 66 in the longitudinal direction Y is set smaller than that of the air freshener F.

As shown in FIGS. 1 and 8, the slide cover 60 is configured to slide from a position where the cover body 61 entirely covers the through-hole 26 in the traverse direction Z to a position where the bottom wall 65 of the accommodating portion 62 entirely covers the through-hole 26 in the traverse direction Z as shown in FIG. 10.

As shown in FIGS. 1 and 8, the position at which the cover body 61 covers the entire through-hole 26 in the traverse direction Z is referred to as closing position, at which the through-hole 26 is closed.

Also, when the bottom wall 65 of the accommodating portion 62 is at a position to cover the entire through-hole 26 in the traverse direction Z as shown in FIG. 10, the interior of the accommodating portion 62 and the interior of the vent passage 10A are continuous with each other through the gaps 66 and the through-hole 26. In the following description, this position is referred to as an open position, at which the through-hole 26 is open.

### First Conversion Mechanism 70

As shown in FIG. 1, the first conversion mechanism 70 is a mechanism that converts rotation of the motor M into motion in the rotation direction R1 in which the upstream fins 40 rotate. A rotation shaft P1 of the motor M rotates in the rotation direction R1.

As shown in FIGS. 1 and 5 to 7, the first conversion mechanism 70 includes an intermittent actuation mechanism 71, which includes a drive source gear 72 and a driven gear 75, a first rack 76, and pinions 77.

The drive source gear 72 is coupled to the rotation shaft P1 and rotates continuously in conjunction with rotation of the motor M about the rotation shaft P1.

As shown in FIGS. 5 to 7, the drive source gear 72 includes a gear body 72A, a notched disc 73, and a first pin 74.

The gear body 72A includes teeth 72a arranged in the circumferential direction (rotation direction R1).

The notched disc 73 has a smaller diameter than the gear body 72A and is formed coaxially and integrally with the gear body 72A.

The notched disc 73 includes a concave surface 73a on the outer circumferential surface and a general surface 73b, which is a section other than the concave surface 73a.

The first pin 74 protrudes from the gear body 72A toward the first side in the traverse direction Z (the front side in the direction orthogonal to the sheet of FIG. 5).

The first pin 74 is arranged outward of the notched disc 73 in the radial direction. Specifically, the first pin 74 is located at a position that corresponds to the concave surface 73a of the notched disc 73 in the radial direction.

The concave surface 73a and the first pin 74 are located at opposite sides of the rotation shaft P1 from the teeth 72a of the gear body 72A.

The driven gear 75 meshes with the drive source gear 72 and is intermittently actuated by the drive source gear 72.

The driven gear 75 is accommodated in the opening portion 35 of the downstream retainer member 30 (refer to FIG. 1) and is configured to rotate in the rotation direction R1 about a rotation shaft P2, which extends in parallel with the rotation shaft P1.

The shape of the driven gear 75 will now be described.

As shown in FIGS. 5 to 7, the driven gear 75 includes, on the outer circumferential surface, a first projecting surface 75a, a second projecting surface 75b, two third projecting surfaces 75c, a first slot 75d, a second slot 75e, two first concave surfaces 75f, and two second concave surfaces 75g.

The second projecting surface 75b is located on an opposite side of the rotation shaft P2 from the first projecting surface 75a. The second projecting surface 75b is farther from the rotation shaft P2 in the radial direction than the first projecting surface 75a is.

The two third projecting surfaces 75c are located between the first projecting surface 75a and the second projecting surface 75b in the circumferential direction.

The first slot 75d extends from a protruding end of the first projecting surface 75a toward the rotation shaft P2.

The second slot 75e extends from a protruding end of the second projecting surface 75b toward the rotation shaft P2.

The two first concave surfaces 75f are located between the first projecting surface 75a and the two third projecting surfaces 75c.

The two second concave surfaces 75g are located between the second projecting surface 75b and the two third projecting surfaces 75c.

As shown in FIGS. 5 to 7, the driven gear 75 is configured to rotate about the rotation shaft P2 when the first pin 74 of the drive source gear 72 is in the first slot 75d, and the first pin 74 slides in the first slot 75d as the drive source gear 72 rotates.

As shown in FIG. 6, the concave surface 73a of the drive source gear 72 functions as a gap into which the first projecting surface 75a escapes when the driven gear 75 rotates.

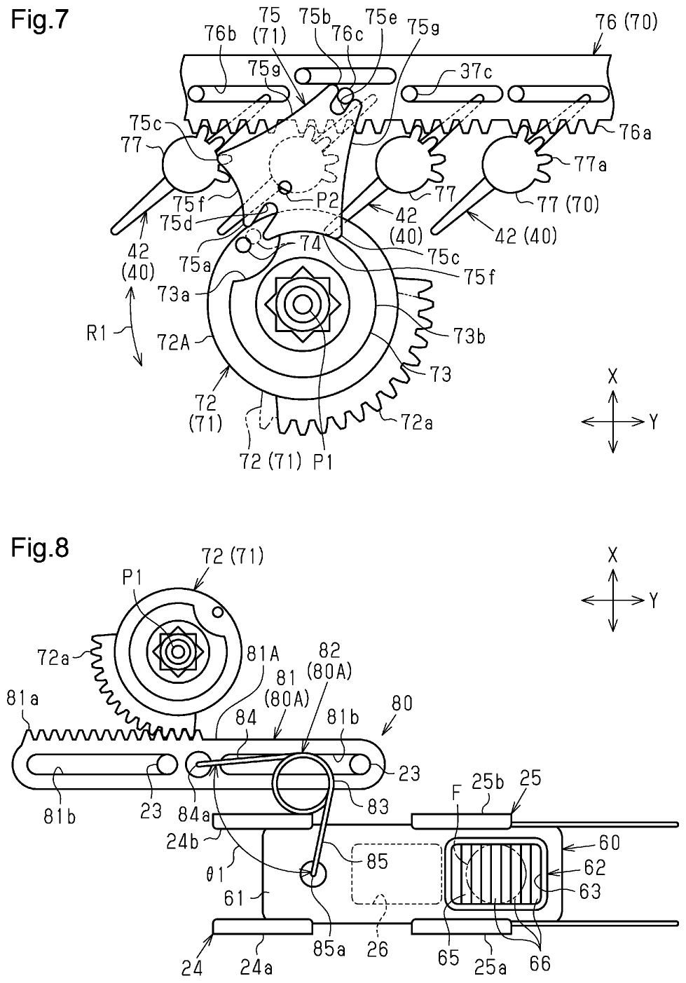

In contrast, as shown in FIGS. 5 and 7, the driven gear 75 is configured not to rotate in association with rotation of the drive source gear 72 when one of the two first concave surfaces 75f slides along the general surface 73b while the driven gear 75 is not meshing with the drive source gear 72, that is, while the first pin 74 is out of the first slot 75d.

In the following description, a period will be referred to as a first phase in which the drive source gear 72 rotates in conjunction with rotation of the motor M toward the first side in the rotation direction R1 from a position indicated by the solid lines in FIG. 5 to a position indicated by the long-dash double-short-dash lines in FIG. 5 (a position at which the drive source gear 72 and the driven gear 75 start meshing with each other). Also, a period in which the drive source gear 72 and the driven gear 75 mesh with each other as shown in FIG. 6 will be referred to as a second phase. A period will be referred to as a third phase in which the drive source gear 72 rotates toward the first side in the rotation direction R1 in conjunction with rotation of the motor M from a position indicated by the long-dash double-short-dash lines in FIG. 7 (a position at which the drive source gear 72 and the driven gear 75 stop meshing with each other) to a position indicated by the solid lines in FIG. 7.

As shown in FIGS. 1 and 3, the first rack 76 has the shape of a flat plate extending in the longitudinal direction Y, and is accommodated between the first outer wall portions 33a of the outer retainer portion 31 and the first inner wall portion 37A of the inner retainer portion 36.

The first rack 76 includes a gear body 76A, first guide holes 76b, and a second pin 76c.

The gear body 76A includes teeth 76a arranged in the longitudinal direction Y on the edge on the upstream side in the flow direction X.

The first guide holes 76b are elongated in the longitudinal direction Y.

Each first guide hole 76b is provided at a position corresponding to one of the first guide projections 37c to accommodate the first guide projection 37c. Thus, the first rack 76 is supported by the first inner wall portion 37A to be slidable in the longitudinal direction Y.

The second pin 76c projects from the gear body 76A toward the first side in the traverse direction Z (upward as viewed in FIG. 3). The second pin 76c is arranged at a position corresponding to the opening portion 35 (refer to FIG. 1).

As shown in FIGS. 5 to 7, the first rack 76 is configured to move linearly in the longitudinal direction Y when the second pin 76c of the first rack 76 is in the second slot 75e, and the second pin 76c slides in the second slot 75e as the driven gear 75 rotates.

As shown in FIGS. 1 and 5 to 7, the pinions 77 are each accommodated between the first outer wall 33a of the outer retainer portion 31 and the first inner wall portion 37A of the inner retainer portion 36 and include teeth 77a meshed with the teeth 76a of the first rack 76.

As shown in FIGS. 1 and 3, the pinions 77 are respectively attached to the upstream fins 40. Specifically, the pinions 77 are respectively formed integrally with the first ends 41a of the first fin pivots 41. Accordingly, when the first rack 76 moves linearly in the longitudinal direction Y, the pinions 77 and the upstream fins 40 are rotated in the direction R1 about the first fin pivots 41.

The number of the teeth 77a of each pinion 77 is set such that the fin bodies 42 of the upstream fins 40 are rotatable between the fin-shut position shown in FIG. 5 and an inclination position shown in FIG. 7.

As shown in FIGS. 5 and 6, the first conversion mechanism 70 is configured such that, while the drive source gear 72 rotates from the first phase to the second phase, the drive source gear 72 and the driven gear 75 mesh with each other, so that the upstream fins 40 rotate in the rotation direction R1 from the fin-shut position.

As shown in FIGS. 6 and 7, the first conversion mechanism 70 is configured such that, while the drive source gear 72 rotates from the second phase to the third phase, the drive source gear 72 and the driven gear 75 do not mesh with each other, so that the upstream fins 40 stop rotating.

### Restriction Mechanism 80A

As shown in FIGS. 1 and 8 to 10, the restriction mechanism 80A includes a second rack 81 and a torsion coil spring 82.

The second rack 81 includes a gear body 81A and second guide slots 81b.

The gear body 81A includes teeth 81a arranged in the longitudinal direction Y on an edge on the downstream side in the flow direction X.

The teeth 81a mesh with the teeth 72a of the drive source gear 72.

The second guide slots 81b are elongated in the longitudinal direction Y.

Each second guide slot 81b is provided at a position corresponding to one of the two second guide projections 23 to accommodates the second guide projection 23. Thus, the second rack 81 is supported by the first wall portion 21a to be slidable in the longitudinal direction Y.

As shown in FIGS. 8 to 10, the torsion coil spring 82 includes a coil portion 83, a first arm 84, and a second arm 85. The first arm 84 and the second arm 85 extend from the coil portion 83.

A distal portion 84a of the first arm 84 is coupled to the second rack 81. Specifically, the distal portion 84a is coupled to a central portion in the longitudinal direction Y of the gear body 81A.

A distal portion 85a of the second arm 85 is coupled to the slide cover 60. Specifically, the distal portion 85a is coupled to a second side in the longitudinal direction Y (left side in the lateral direction in FIGS. 8 to 10) of the cover body 61.

The restriction mechanism 80A is configured such that, while the drive source gear 72 rotates from the first phase to the second phase, the second rack 81 slides toward the first side in the longitudinal direction Y (the right side in FIGS. 8 to 10), thereby applying a load in the winding direction of the coil portion 83 to the torsion coil spring 82.

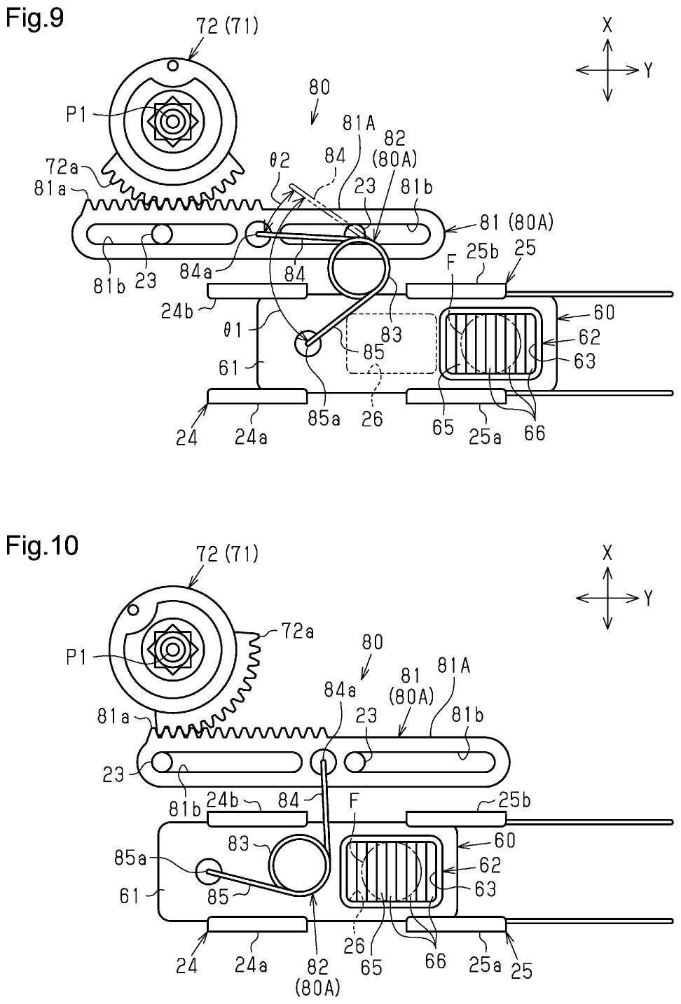

As shown in FIG. 9, when the torsion coil spring 82 receives a load in the winding direction, the angle θ defined by the first arm 84 and the second arm 85 is reduced from an angle θ1 in a free state by a torsion angle θ2. The torsion coil spring 82 accumulates elastic force in the unwinding direction of the coil portion 83 while the angle θ2 is reduced to a prescribed torsion angle.

As shown in FIGS. 8 and 9, the restriction mechanism 80A utilizes the property of the torsion coil spring 82 to accumulate elastic force in the torsion coil spring 82 until the angle θ2 reaches the prescribed angle, thereby restricting sliding motion of the slide cover 60 from the closed position to the open position.

The restriction mechanism 80A is configured to allow the slide cover 60 to slide from the closed position to the open position by the elastic force when the angle θ2 reaches the prescribed torsion angle, as shown in FIG. 10.

The restriction mechanism 80A is configured such that the angle θ2 reaches the prescribed angle while the drive source gear 72 is rotated from the second phase to the third phase.

In the present embodiment, the restriction mechanism 80A and the teeth 72a of the drive source gear 72 form a second conversion mechanism 80, which is a mechanism that converts rotation of the motor M to linear motion of the slide cover 60 in the longitudinal direction Y.

Operation and advantages of the first embodiment will now be described.

(1-1) The air-conditioning register 100 includes the first conversion mechanism 70, which converts rotation of the motor M into motion in the rotation direction R1, in which the upstream fins 40 rotate, and the second conversion mechanism 80, which converts rotation of the motor M into motion in the longitudinal direction Y, in which the slide cover 60 moves.

With this configuration, the first conversion mechanism 70 and the second conversion mechanism 80 convert rotation of the single motor M into motion in the rotation direction R1 and motion in the longitudinal direction Y, thereby actuating the upstream fins 40 and the slide cover 60. This configuration limits the increase in the size of the air-conditioning register 100 as compared with a case in which the upstream fins 40 and the slide cover 60 are actuated by multiple motors M.

(1-2) The first conversion mechanism 70 includes the intermittent actuation mechanism 71. The intermittent actuation mechanism 71 includes the drive source gear 72, which rotates continuously in conjunction with rotation of the motor M, and the driven gear 75, which is intermittently actuated by the drive source gear 72.

With this configuration, in the first conversion mechanism 70, which includes the intermittent actuation mechanism 71, rotation of the motor M is converted into motion in the rotation direction R1, in which the upstream fins 40 are rotated by the drive source gear 72 and the driven gear 75. This actuates the upstream fins 40 intermittently.

(1-3) The first conversion mechanism 70 includes the first rack 76 and the pinions 77, which are respectively provided on the upstream fins 40 and meshed with the first rack 76. The first conversion mechanism 70 is configured to rotate the upstream fins 40 in the rotation direction R1 by converting rotation of the motor M into rotation of the pinions 77 via the linear motion of the first rack 76.

With this configuration, the first conversion mechanism 70 converts rotation of the motor M into rotation of the pinions 77 via linear motion of the first rack 76 in the longitudinal direction Y. Accordingly, the upstream fins 40 are rotated in the rotation direction R1 about the respective first fin pivots 41. Thus, the airflow direction of the air-conditioning air A blown out from the retainer 10 is readily changed by the driving force of the motor M.

(1-4) The retainer 10 includes the through-hole 26. The second conversion mechanism 80 converts rotation of the motor M into linear motion in the longitudinal direction Y, thereby causing the slide cover 60 to slide from the closed position, at which the through-hole 26 is closed, to the open position, at which the through-hole 26 is opened. The slide cover 60 includes the accommodating portion 62, which accommodates the air freshener F, which is a chemical agent, and is continuous with the vent passage 10A through the through-hole 26 when the slide cover 60 is at the open position.

With this configuration, rotation of the motor M is converted into linear motion in the longitudinal direction Y by the second conversion mechanism 80, so that the slide cover 60 slides in the longitudinal direction Y. This causes the slide cover 60 to slide from the closed position to the open position. When the slide cover 60 is at the open position, the accommodating portion 62, which accommodates the air freshener F, and the vent passage 10A are continuous with each other through the gaps 66 and the through-hole 26. Accordingly, the fragrance of the air freshener F flows into the vent passage 10A via the through-hole 26. This imparts the fragrance of the air freshener F to the air-conditioning air A blown out from the retainer 10.

(1-5) The first conversion mechanism 70 is configured to rotate the upstream fins 40 in the rotation direction R1 by causing the drive source gear 72 to mesh with the driven gear 75 while the drive source gear 72 rotates from the first phase to the second phase. The first conversion mechanism 70 is also configured such that, while the drive source gear 72 rotates from the second phase to the third phase, which is on the opposite side from the first phase, the drive source gear 72 and the driven gear 75 do not mesh with each other, so that the upstream fins 40 stop rotating. While the drive source gear 72 rotates from the first phase to the second phase, the restriction mechanism 80A of the second conversion mechanism 80 restricts the slide cover 60 from sliding from the closed position to the open position. In contrast, while the drive source gear 72 rotates from the second phase to the third phase, the restriction mechanism 80A permits the slide cover 60 to slide from the closed position to the open position.

With this configuration, while the drive source gear 72 rotates from the first phase to the second phase in conjunction with rotation of the motor M, the drive source gear 72 and the driven gear 75 mesh with each other. This converts rotation of the drive source gear 72 into linear motion of the first rack 76 in the longitudinal direction Y via the driven gear 75. As a result, the upstream fins 40 are rotated in the rotation direction R1 about the respective first fin pivots 41. At this time, in the second conversion mechanism 80, while the rotation of the drive source gear 72 continues to be converted into linear motion of the second rack 81 in the longitudinal direction Y, the torsion coil spring 82 restricts the slide cover 60 from moving from the closed position to the open position.

Subsequently, while the drive source gear 72 is rotated from the second phase to the third phase, the drive source gear 72 and the driven gear 75 do not mesh with each other, which stops the rotation of the driven gear 75. This stops the rotation of the upstream fins 40. In this case, the restriction mechanism 80A allows the slide cover 60 to slide from the closed position to the open position.

Therefore, the single motor M can independently perform two functions: actuating the multiple upstream fins 40 to change the airflow direction of the air-conditioning air A flowing from the retainer 10, and moving the slide cover 60 to the open position to impart the fragrance of the air freshener F to the air-conditioning air A.

(1-6) The number of the teeth of each pinion 77 is set such that the upstream fins 40 can rotate to the fin-shut position. The first conversion mechanism 70 is configured to cause the upstream fins 40 to rotate from the fin-shut position by causing the drive source gear 72 to mesh with the driven gear 75 when the drive source gear 72 rotates from the first phase to the second phase in conjunction with rotation of the motor M.

With this configuration, when the upstream fins 40 are rotated to the fin-shut position, fins that contact each other and overlap with each other close the vent passage 10A, so that the air-conditioning air A is stopped from being blown out from the retainer 10. When the drive source gear 72 rotates from the first phase to the second phase in conjunction with rotation of the motor M, the upstream fins 40 rotate in the direction R1 from the fin-shut position about the first fin pivots 41. This starts blowing of the air-conditioning air A from the retainer 10 and changes the airflow direction of the air A. Therefore, it is possible to independently initiate the discharge of the air-conditioning air A from the retainer 10, while also adjusting its airflow direction, and to open the slide cover 60 to impart the fragrance of the air freshener F to the air-conditioning air A.

(1-7) The second conversion mechanism 80 is configured to slide the slide cover 60 from the closed position to the open position by converting rotation of the motor M into linear motion of the drive source gear 72 in the longitudinal direction Y.

With this configuration, rotation of the motor M is transmitted to the second conversion mechanism 80 via the drive source gear 72 of the first conversion mechanism 70, so that the rotation is converted into linear motion in the longitudinal direction Y. Thus, there is no need to provide the second conversion mechanism 80 with an additional means for transmitting rotation of the motor M by rotating in conjunction with the rotation of the motor M. The configuration of the second conversion mechanism 80 is thus simplified.

### Second Embodiment

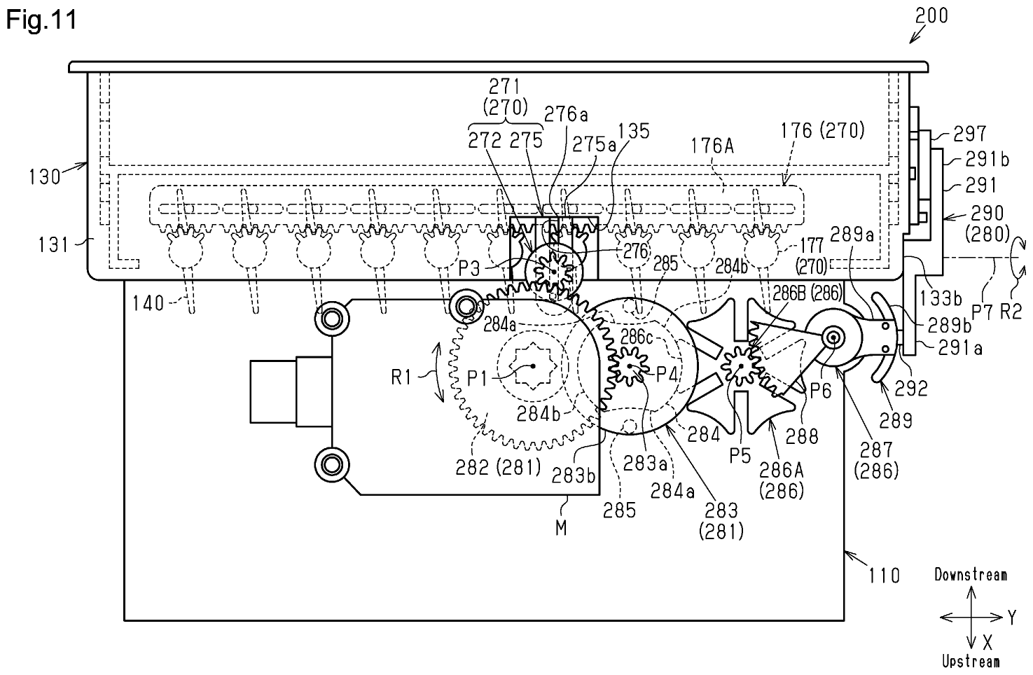

An air-conditioning register 200 according to a second embodiment will now be described with reference to FIGS. 11 to 24. Differences from the first embodiment will mainly be discussed. In the second embodiment, reference numerals 1**, which are obtained by adding 100 to the reference numerals ** in the first embodiment, are given to components that are the same as or correspond to the components in the first embodiment, and redundant explanations are omitted.

### Basic Configuration of Air-Conditioning Register 200

As shown in FIG. 11, the air-conditioning register 200 includes a first conversion mechanism 270, which is attached to the outer side of the retainer 110, and a second conversion mechanism 280.

In the second embodiment, upstream fins 140 and downstream fins 150 correspond to the movable members according to the present disclosure.

Each configuration will now be described.

### First Conversion Mechanism 270

As shown in FIG. 11, the first conversion mechanism 270 includes a Scotch yoke mechanism 271, a first rack 176, and pinions 177.

The Scotch yoke mechanism 271 includes a gear portion 272 and a U-shaped rod portion 275, which are accommodated in an opening portion 135 of a downstream retainer member 130.

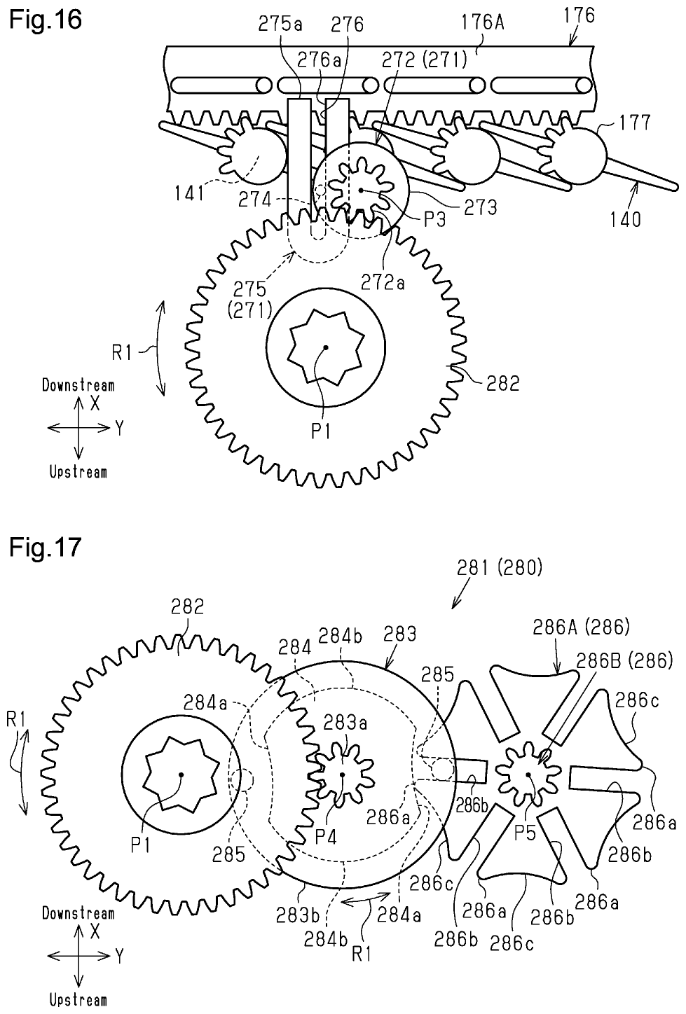

As shown in FIGS. 15 and 16, the gear portion 272 rotates in a rotation direction R1 about a rotation shaft P3, which extends parallel with a rotation shaft P1. The gear portion 272 includes a gear body 272A, a disc portion 273, and a first guide projection 274.

The gear body 272A includes teeth 272a arranged in the circumferential direction (rotation direction R1) on the outer circumferential surface. The teeth 272a are provided over the entire outer circumferential surface of the gear body 272A.

The disc portion 273 has a larger diameter than the gear body 272A and is formed coaxially and integrally with the gear body 272A.

The first guide projection 274 projects from the disc portion 273 toward a second side in the traverse direction Z (the back side in the direction orthogonal to the sheet of FIGS. 15 and 16).

As shown in FIG. 11, the rod portion 275 includes a guide slot 276, which extends in the flow direction X. The rod portion 275 includes an opening 276a, which is continuous with the downstream end of the guide slot 276. The opening 276a is closed by the opening portion 135.

As shown in FIGS. 15 and 16, the guide slot 276 accommodates the first guide projection 274 of the gear portion 272.

The rod portion 275 has two distal portions 275a on the downstream end. The distal portions 275a are integrally coupled to a gear body 176A of the first rack 176. Specifically, the distal portions 275a are integrally coupled to a first side in the traverse direction Z (front side in the direction orthogonal to the sheet of FIGS. 15 and 16) of the first rack 176.

In the Scotch yoke mechanism 271, the first guide projection 274 is accommodated in the guide slot 276. The Scotch yoke mechanism 271 is configured such that, when the gear portion 272 rotates, the first guide projection 274 slides in the guide slot 276, so that the rod portion 275 moves linearly in the longitudinal direction Y.

### Second Conversion Mechanism 280

As shown in FIG. 11, the second conversion mechanism 280 is a mechanism that converts rotation of the motor M in the rotation direction R1 into motion in the rotation direction R2 in which the downstream fins 150 rotate. In the second embodiment, the rotation direction R2 corresponds to the second direction according to the present disclosure.

The second conversion mechanism 280 includes an intermittent actuation mechanism 281, a downstream fin actuation mechanism 290, and a rotation plane conversion mechanism 287. The intermittent actuation mechanism 281 includes a drive source gear 282, an intermediate gear 283, and a driven gear 286

As shown in FIGS. 11 and 17, the drive source gear 282 is coupled to the rotation shaft P1 and rotates continuously in conjunction with rotation of the motor M about the rotation shaft P1.

As shown in FIGS. 15 and 16, the drive source gear 282 meshes with the teeth 272a of the gear portion 272.

As shown in FIGS. 11 and 17, the intermediate gear 283 is supported to be rotatable the rotation direction R1 about a rotation shaft P4, which extends parallel with the rotation shaft P1. The intermediate gear 283 includes a gear body 283a, a disc portion 283b, a notched disc 284, and two pins 285.

The gear body 283a, the disc portion 283b, and the notched disc 284 are formed coaxially and integrally. The gear body 283a is a gear having a smaller diameter than the drive source gear 282 and meshes with the drive source gear 282.

The disc portion 283b and the notched disc 284 have a larger diameter than the gear body 283a.

The notched disc 284 includes two concave surfaces 284a on the outer circumferential surface and a general surface 284b, which is a section other than the concave surfaces 284a. One of the concave surfaces 284a is located on a side of the rotation shaft P4 that is opposite to the other concave surface 284a. In other words, the two concave surfaces 284a are located at positions separated from each other by 180° in the circumferential direction.

The two pins 285 protrude from the disc portion 283b toward the second side in the traverse direction Z (the back side of the sheet of FIG. 11).

The pins 285 are located at positions that respectively correspond to the two concave surfaces 284a of the notched disc 284 in the radial direction. That is, the two pins 285 are located at positions separated from each other by 180° in the circumferential direction.

As shown in FIGS. 11 and 17, the driven gear 286 is intermittently actuated by the drive source gear 282 via the intermediate gear 283. The driven gear 286 is supported by a rotation shaft P5, which extends in parallel with the rotation shaft P1, so as to be rotatable in the rotation direction R1.

The driven gear 286 includes a first gear portion 286A and a second gear portion 286B.

The first gear portion 286A is meshed with the intermediate gear 283 and includes projecting surfaces 286a, radial slots 286b, and concave surfaces 286c.

The projecting surfaces 286a are provided on the outer circumferential surface of the first gear portion 286A at equal intervals in the circumferential direction. In the present embodiment, six projecting surfaces 286a are provided.

The radial slots 286b extend from the tips of the respective projecting surfaces 286a toward the rotation shaft P5.

The concave surfaces 286c are each located between adjacent ones of the projecting surfaces 286a in the circumferential direction.

The second gear portion 286B is a gear having a smaller diameter than that of the first gear portion 286A, and is formed integrally with and coaxial with the first gear portion 286A.

As shown in FIG. 17, the driven gear 286 is configured to rotate about the rotation shaft P5 when one of the first pins 285 of the intermediate gear 283 is in one of the radial slots 286b, and the pin 285 slides in the radial slot 286b as the intermediate gear 283 rotates.

The two concave surfaces 284a of the intermediate gear 283 function as gaps into which the projecting surfaces 286a escape when the driven gear 286 rotates.

As shown in FIG. 11, the driven gear 286 is configured not to rotate in accordance with rotation of the intermediate gear 283 when one of the concave surfaces 286c slides along the general surface 284b while the driven gear 286 is not meshing with the intermediate gear 283, that is, while both pins 285 are out of the radial slots 286b.

In the present embodiment, the intermittent actuation mechanism 281 is configured to rotate the driven gear 286 in the rotation direction R1 by 60 degrees each time the intermediate gear 283 rotates a half turn in the rotation direction R1.

### Downstream Fin Actuation Mechanism 290

The downstream fin actuation mechanism 290 of the second conversion mechanism 280 will now be described.

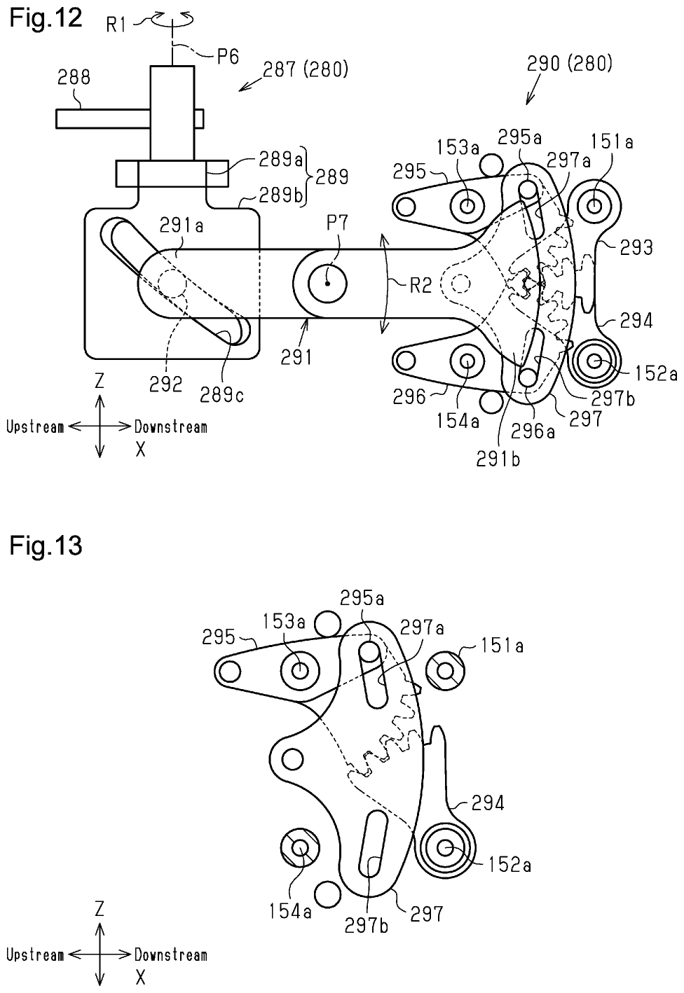

As shown in FIG. 12, the downstream fin actuation mechanism 290 includes an arm portion 291, two first drive gears 293, 294, two second drive gears 295, 296, and a coupling portion 297.

As shown in FIGS. 11 and 12, the arm portion 291 is supported by a second outer wall portion 133b of an outer retainer portion 131 so as to be rotatable in the rotation direction R2 about a rotation axis P7.

The arm portion 291 includes an engagement projection 292.

The engagement projection 292 projects from an upstream end portion 291a of the arm portion 291 toward a second side in the longitudinal direction Y (the left side in the lateral direction in FIG. 11). The end portion 291a corresponds to the second end in the extending direction of the arm portion according to the present disclosure.

As shown in FIGS. 11 and 12 to 14, the two first drive gears 293, 294 rotate the first downstream fins 151, 152 in the rotation direction R2 and are fixed to the end portions of the second fin pivots 151a, 152a.

The two second drive gears 295, 296 rotate the second downstream fins 153, 154 in the rotation direction R2 and are fixed to the end portions of the second fin pivots 153a, 154a.

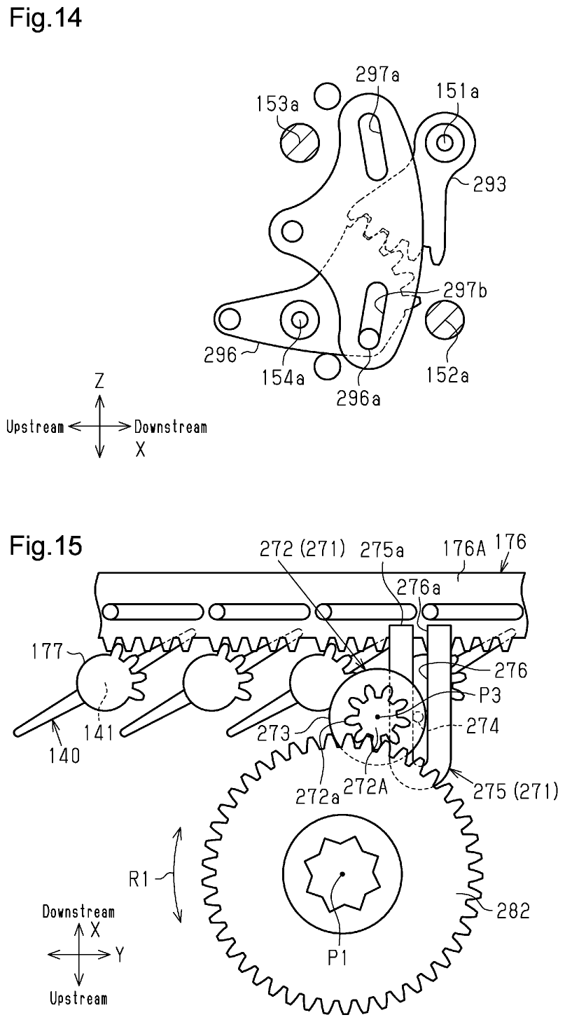

The first drive gear 293 and the second drive gear 296 mesh with each other (refer to FIG. 14).

The first drive gear 294 and the second drive gear 295 mesh with each other (refer to FIG. 13).

The second drive gears 295, 296 include protrusions 295a, 296a, respectively.

The protrusions 295a, 296a project toward a first side in the longitudinal direction Y (the front side in the direction orthogonal to the sheet of FIG. 12).

As shown in FIGS. 11 and 12, the coupling portion 297 is fixed to a downstream end portion 291b of the arm portion 291. The end portion 291b corresponds to the first end in the extending direction of the arm portion according to the present disclosure.

As shown in FIGS. 12 to 14, the coupling portion 297 includes two second guide slots 297a, 297b. The second guide slots 297a, 297b accommodate the protrusions 295a, 296a, respectively. As such, the coupling portion 297 couples the arm portion 291 and the two second drive gears 295, 296 to each other.

### Rotation Plane Conversion Mechanism 287

The rotation plane conversion mechanism 287 of the second conversion mechanism 280 will now be described.

As shown in FIGS. 11 and 12, the rotation plane conversion mechanism 287 includes a sector gear 288 and the plate portion 289.

The sector gear 288 is supported to be rotatable in the rotation direction R1 about a rotation shaft P6, which is parallel to the rotation shaft P1. The sector gear 288 meshes with the second gear portion 286B of the driven gear 286. The sector gear 288 corresponds to the first gear according to the present disclosure.

The plate portion 289 is provided to be rotatable in the rotation direction R1 integrally with the sector gear 288 about the rotation shaft P6.

The plate portion 289 includes a support portion 289a and a plate body 289b.

The support portion 289a supports the plate body 289b and extends from the rotary shaft P6 toward the side opposite to the sector gear 288.

The plate body 289b is coupled to the distal end of the support portion 289a. The plate body 289b is curved in the rotation direction R1 (refer to FIG. 11).

As shown in FIG. 12, the plate body 289b includes an elongated slot 289c. The elongated slot 289c extends along one of the two diagonal lines (not shown) of the plate body 289b that is inclined to be closer to the first side in the traverse direction Z (the upper side in the vertical direction in FIG. 12) toward the upstream side in the flow direction X.

The elongated slot 289c accommodates the engagement projection 292 of the arm portion 291.

As shown in FIGS. 12, 19, and 22, the elongated slot 289c is configured such that, when the plate portion 289 rotates in the rotation direction R1 in conjunction with rotation of the sector gear 288, the engagement projection 292 slides in the elongated slot 289c, such that the arm portion 291 rotates in the rotation direction R2 about the rotation shaft P7.

In the present embodiment, when the components of the second conversion mechanism 280 are at the positions shown in FIGS. 11 to 14, the downstream fins 150 are at a neutral position shown in FIG. 3.

Operation of the second embodiment will now be described.

When the drive source gear 282 rotates in conjunction with rotation of the motor M, the gear portion 272, which meshes with the drive source gear 282, rotates in the rotation direction R1 in the Scotch yoke mechanism 271 of the first conversion mechanism 270. When the gear portion 272 rotates as the drive source gear 282 rotates, the rod portion 275 slides in the longitudinal direction Y as shown in FIGS. 15 and 16. The distal portions 275a of the rod portion 275 are integrally coupled to the gear body 176A of the first rack 176. Thus, the first rack 176 slides integrally with the rod portion 275 in the longitudinal direction Y. That is, the Scotch yoke mechanism 271 converts rotation of the drive source gear 282 into linear motion of the first rack 176 in the longitudinal direction Y. This rotates the upstream fins 140 in the direction R1 about the respective first fin pivots 141. As a result, the airflow direction of the air-conditioning air A blown out from the retainer 110 is changed in the longitudinal direction Y (the lateral direction as viewed in FIGS. 15 and 16).

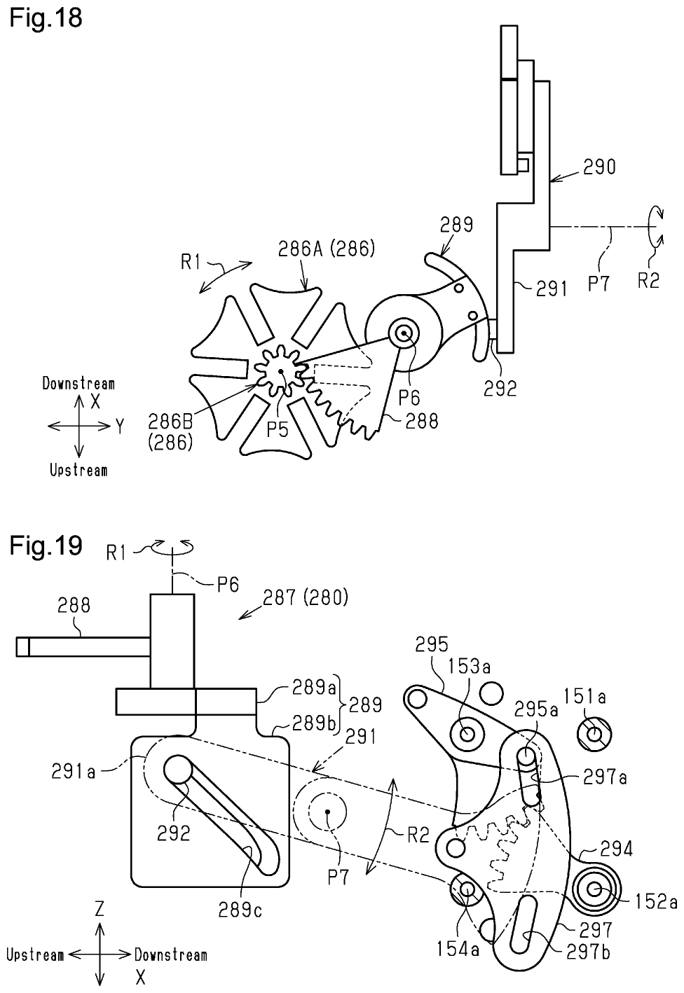

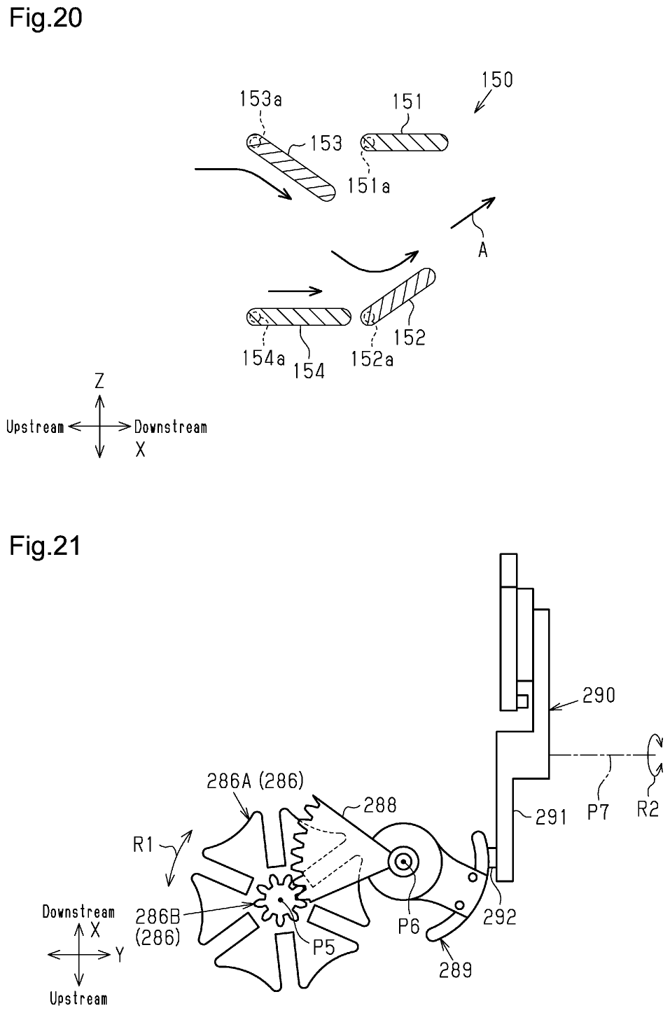

In the second conversion mechanism 280, when the drive source gear 282 rotates in conjunction with rotation of the motor M, the driven gear 286 rotates through the intermediate gear 283, so that the sector gear 288 rotates. For example, when the sector gear 288 rotates toward the first side in the rotation direction R1 as shown in FIGS. 11 and 18, the engagement projection 292 of the arm portion 291 slides in the elongated slot 289c from the middle position shown in FIG. 12 toward the first end as shown in FIG. 19. Thus, the arm portion 291 rotates about the rotation shaft P7 toward the first side in the direction R2. At this time, the protrusion 295a of the second drive gear 295 is pushed toward the second side in the traverse direction Z (the lower side in FIGS. 12 and 19) by the inner surface of the second guide slot 297a on the first side in the traverse direction Z (the upper side in the vertical direction in FIGS. 12 and 19). Accordingly, the second drive gear 295 is rotated about the second fin pivot 153a from the position shown in FIG. 13 to the position shown in FIG. 19 toward the first side in the rotation direction R2. Further, the first drive gear 294, which meshes with the second drive gear 295, is rotated about the second fin pivot 152a toward the second side in the rotation direction R2. Accordingly, the first downstream fin 152 and the second downstream fin 153 are rotated from the neutral position to the inclined positions shown in FIG. 20. As a result, the airflow direction of the air-conditioning air A blown out from the retainer 110 is changed toward the first side in the traverse direction Z (the upper side in the vertical direction in FIG. 20).

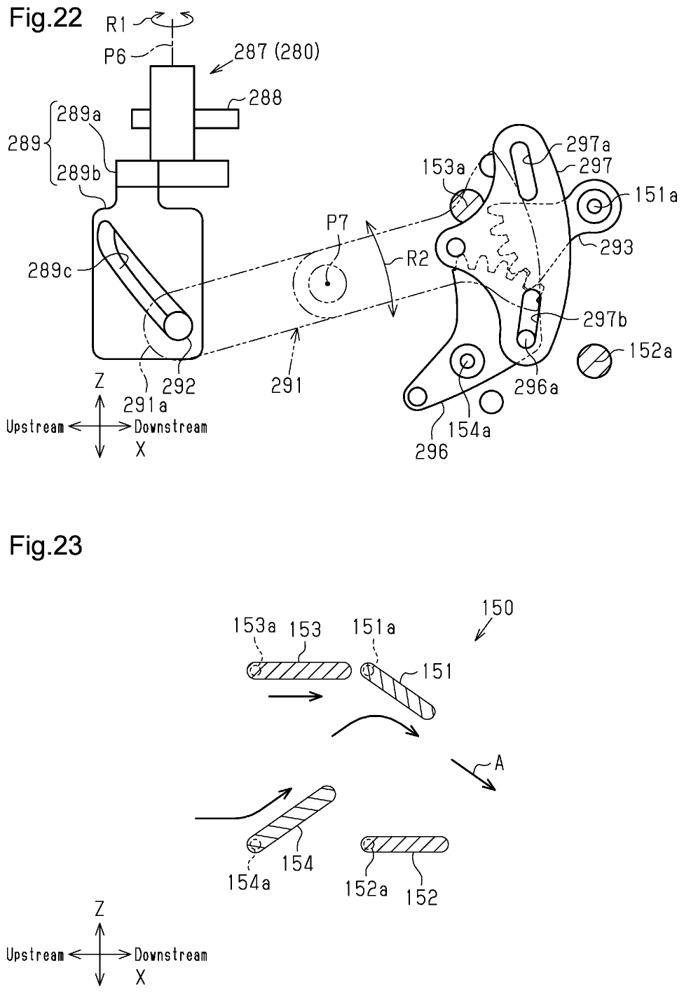

Also, in the second conversion mechanism 280, when the sector gear 288 rotates toward the second side in the rotation direction R1 as shown in FIGS. 11 and 21, the engagement projection 292 of the arm 291 slides toward the second end in the elongated slot 289c from the middle position shown in FIG. 12, as shown in FIG. 22. Thus, the arm 291 rotates about the rotation shaft P7 toward the second side in the rotation direction R2. At this time, the protrusion 296a of the second drive gear 296 is pushed toward the first side in the traverse direction Z (the upper side in FIGS. 12 and 22) by the inner surface of the second guide slot 297b on the second side in the traverse direction Z (the lower side in the vertical direction in FIGS. 12 and 22). Accordingly, the second drive gear 296 is rotated about the second fin pivot 154a from the position shown in FIG. 14 to the position shown in FIG. 22 toward the second side in the rotation direction R2. Further, the first drive gear 293, which meshes with the second drive gear 296, is rotated about the second fin pivot 151a toward the first side in the rotation direction R2. Accordingly, the first downstream fin 151 and the second downstream fin 154 are rotated from the neutral position to the inclined positions shown in FIG. 23. As a result, the airflow direction of the air-conditioning air A blown out from the retainer 110 is changed toward the second side in the traverse direction Z (the lower side in the vertical direction in FIG. 23).

The second embodiment has the following advantages.

(2-1) The air-conditioning register 200 includes the downstream fins 150, which serve as movable members. The second conversion mechanism 280 converts rotation of the motor M into rotation in the rotation direction R2, thereby actuating the downstream fins 150.

With this configuration, the second conversion mechanism 280 converts rotation of the motor M into rotation in the rotation direction R2, so as to rotate the downstream fins 150 in the rotation direction R2. Thus, the airflow direction of the air-conditioning air A blown out from the retainer 10 is readily changed by the driving force of the motor M.

(2-2) The second conversion mechanism 280 includes the intermittent actuation mechanism 281. The intermittent actuation mechanism 281 includes the drive source gear 282, which rotates continuously in conjunction with rotation of the motor M, the intermediate gear 283, and the driven gear 286, which is intermittently actuated by the drive source gear 282 via the intermediate gear 283. The second conversion mechanism 280 is configured to actuate, each time the intermediate gear 283 is rotated by the prescribed angle, the driven gear 286 intermittently to rotate the downstream fins 150 in the rotation direction R2.

With this configuration, each time the intermediate gear 283 is rotated by the prescribed angle in conjunction with rotation of the motor M, the intermediate gear 283 and the driven gear 286 mesh with each other. This converts rotation of the intermediate gear 283 into rotation in the rotation direction R2 via the driven gear 286. As a result, the downstream fins 150 are rotated in the rotation direction R2. When the intermediate gear 283 and the driven gear 286 do not mesh with each other, rotation of the driven gear 286 is stopped. That is, rotation of the downstream fins 150 is stopped.

On the other hand, while the motor M rotates, the rotation of the motor M continues to be converted into rotation in the rotation direction R1 by the first conversion mechanism 270, so that the upstream fins 140 are continuously rotated in the rotation direction R1.

Therefore, the single motor M can independently perform a mode for actuating only the upstream fins 140 (actuation mode 1) and a mode for actuating both the upstream fins 140 and the downstream fins 150 (actuation mode 2).

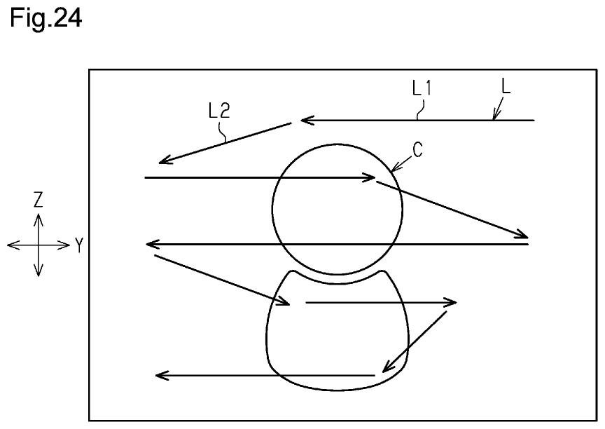

FIG. 24 shows how the air-conditioning air A blown out into the passenger compartment from the retainer 110 is shifted in relation to an occupant C in the passenger compartment. Specifically, FIG. 24 illustrates one example of a trajectory L of a spot through which the airflow of the air-conditioning air A passes in the above-described actuation modes. In the case of the actuation mode 1, the spot shifts along a trajectory L1 extending in the longitudinal direction Y. In the case of the actuation mode 2, the spot shifts along a trajectory L2, which is inclined relative to the trajectory L1. In the air-conditioning register 200 of the present embodiment, while the drive source gear 282 rotates continuously in conjunction with rotation of the motor M, the spot is shifted alternately repeatedly along the trajectory L1 and the trajectory L2, so that the spot is shifted along a series of trajectories L.

With the above-described configuration, the prescribed angle is changed to change the timing at which the actuation mode 1 and the actuation mode 2 are switched. It is thus possible to change the trajectory L of the spot through which the airflow of the air-conditioning air A passes, during rotation of the drive source gear 282.

(2-3) The first conversion mechanism 270 is configured to rotate the upstream fins 140 in the rotation direction R1 by converting rotation of the motor M into linear motion of the first rack 176 in the longitudinal direction Y via rotation of the drive source gear 282.

With this configuration, rotation of the motor M is converted into linear motion of the first rack 176 in the longitudinal direction Y by the drive source gear 282 of the second conversion mechanism 280. This rotates the pinions 177, so that the upstream fins 140 are rotated in the rotation direction R1. Thus, there is no need to provide the first conversion mechanism 270 with an additional means for transmitting rotation of the motor M by rotating in conjunction with the rotation of the motor M. The configuration of the first conversion mechanism 270 is thus simplified.

(2-4) The second conversion mechanism 280 includes the downstream fin actuation mechanism 290. The downstream fin actuation mechanism 290 includes the arm portion 291, the drive gears 293, 294, 295, 296, which rotate the downstream fins 150 in the rotation direction R2, and the coupling portion 297. The second conversion mechanism 280 also includes the rotation plane conversion mechanism 287. The rotation plane conversion mechanism 287 includes the sector gear 288 and the plate portion 289, which is rotatable integrally with the sector gear 288 in the rotation direction R1. The arm portion 291 includes the engagement projection 292. The plate portion 289 includes the elongated slot 289c, which is configured such that the engagement projection 292 slides in the elongated slot 289c to allow the downstream fin actuation mechanism 290 to rotate in the rotation direction R2.

With this configuration, rotation in the rotation direction R1 of the motor M is converted into rotation in the rotation direction R2 of the downstream fin actuation mechanism 290 by rotation in the rotation direction R1 of the plate portion 289, which includes the elongated slot 289c, and the accompanying sliding motion of the engagement projection 292 in the elongated slot 289c. Thus, the second conversion mechanism 280 is readily embodied by the rotation plane conversion mechanism 287 and the downstream fin actuation mechanism 290.

### Modifications

The above-described embodiments may be modified as follows. The above-described embodiments and the following modifications can be combined as long as the combined modifications remain technically consistent with each other.

The air-conditioning register 200 may be configured such that the occupant C selects a spot on an image of the trajectory L shown on a touch-screen in the passenger compartment. Accordingly, the motor M rotates to change the airflow direction such that the spot through which the airflow passes agrees with the selected spot on the actual trajectory L.

The first conversion mechanism 270 may include an additional gear between the drive source gear 282 and the gear portion 272 (modification 1). The additional gear meshes with the gear portion 272 and continuously rotates in conjunction with rotation of the drive source gear 282.

The first conversion mechanism 270 does not necessarily need to be configured such that the gear portion 272 meshes with the drive source gear 282 of the second conversion mechanism 280. The first conversion mechanism 270 may include an additional means for converting rotation of the motor M into rotation of the gear portion 272 by rotating in conjunction with rotation of the motor M.

The first gear according to the present disclosure is not limited to the sector gear 288 as described in the second embodiment, but may be shaped in any manner as long as it can be employed with the rotation plane conversion mechanism 287.

The intermittent actuation mechanism 281 does not necessarily need to include the drive source gear 282, the intermediate gear 283, and the driven gear 286. For example, one or more gears may be provided between the drive source gear 282 and the intermediate gear 283. When multiple gears are provided, the gears may include a gear that rotates continuously in conjunction with rotation of the drive source gear 282 and a gear that is intermittently actuated by the continuously rotating gear.

When combined with the above-described modification 1, this configuration can change the arrangement of the motor M.

The intermittent actuation mechanism 281 does not necessarily need to rotate the driven gear 286 by 60 degrees each time the intermediate gear 283 rotates 180 degrees as described in the second embodiment. The timing at which the gears mesh with each other may be changed by changing the number of pins 285 of the intermediate gear 283 and the number of radial slots of the driven gear 286.

This configuration can change the timing at which the path L1 and the path L2 are switched.

In the second embodiment, the upstream fins 140 and the downstream fins 150 are used as movable members that are actuated by the motor M. However, the multiple movable members in the air-conditioning register 200 are not limited to these. For example, a slide cover may be included in the multiple movable members actuated by the motor M by actuating the second rack 81, which is described in the first embodiment, via the drive source gear 282.

The second conversion mechanism 280 does not necessarily need to include the intermittent actuation mechanism 281.

The downstream fins 50 may be actuated by the motor M like the downstream fins 150 described in the second embodiment. Alternatively, the downstream fins 50 may be actuated manually by an additional operating knob or the like.

The second conversion mechanism 80 may include an additional gear between the drive source gear 72 and the second rack 81 (Modification 2). The additional gear meshes with the second rack 81 and continuously rotates in conjunction with rotation of the drive source gear 72.

The second conversion mechanism 80 does not necessarily need to be configured such that the second rack 81 meshes with the drive source gear 72 of the first conversion mechanism 70. The second conversion mechanism 80 may include an additional means for converting rotation of the motor M into linear motion in the longitudinal direction Y of the second rack 81 by rotating in conjunction with rotation of the motor M.

The intermittent actuation mechanism 71 does not necessarily need to include the drive source gear 72 and the driven gear 75. For example, one or more gears may be provided between the driven gear 75 and a gear that is coupled to the rotation shaft P1 and rotates about the rotation shaft P1. In this case, the shape of the gear meshing with the driven gear simply needs to be the same as the shape of the drive source gear 72. When multiple gears are provided, the gears may include a gear that rotates continuously in conjunction with rotation of the actuator and a gear that is intermittently actuated by the continuously rotating gear.

When combined with the above-described modification 2, this configuration can change the arrangement of the motor M.

The upstream fins 40 do not necessarily need to be configured such that each adjacent pair of the fin bodies 42 can rotate to the fin-shut position, at which the fin bodies 42 overlap with each other.

The chemical agent according to the present disclosure is not limited to the air freshener F described in the first embodiment, but may be, for example, a deodorizing agent or an insect repellent.

The first conversion mechanism 70 does not have to include the intermittent actuation mechanism 71.

The actuator according to the present disclosure is not limited to the motor M, which includes a rotation shaft that rotates in the rotation direction R1, described in the above-described embodiments. For example, the actuator may be a motor that includes a rotation shaft that rotates in the rotation direction R2. Further, any actuator other than a motor may be used as long as that actuator is applicable to the present disclosure.

The movable members according to the present disclosure are not limited to the upstream fins 40 and the slide cover 60 as described in the first embodiment or the combination of the upstream fins 140 and the downstream fins 150 as described in the second embodiment. For example, the multiple movable members may be embodied by a combination of a slide cover that is supported by the retainer so as to be slidable in the longitudinal direction Y and opens and closes the through-hole, and multiple downstream fins that are provided so as to be rotatable about the second fin shafts in the rotation direction R2. In this case, the longitudinal direction Y corresponds to the first direction according to the present disclosure, and the rotation direction R2 corresponds to the second direction according to the present disclosure.

The present disclosure may be employed in any air-conditioning register that includes two or more movable members. In this case, a conversion mechanism corresponding to each movable member is provided. Also, in this case, an intermittent actuation mechanism may be included in any one of the conversion mechanisms. Movable members other than the ones described in the above-described embodiments include a shut-off damper for adjusting the blow-out amount of air-conditioning air from an outlet.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An air-conditioning register, comprising:
a retainer that forms a vent passage for air-conditioning air;
multiple movable members that are attached to the retainer and movable in different directions;
an actuator that rotates to actuate the movable members; and
multiple conversion mechanisms that convert rotation of the actuator into motion in directions in which the movable members move, thereby actuating the movable members.

2. The air-conditioning register according to claim 1, wherein
the conversion mechanisms include an intermittent actuation mechanism, and
the intermittent actuation mechanism includes:
a drive source gear that rotates continuously in conjunction with the rotation of the actuator; and
a driven gear that is actuated intermittently by the drive source gear.

3. The air-conditioning register according to claim 1, wherein
the movable members include multiple fins that are rotatable in a first direction about multiple fin pivots, the fin pivots being located in the vent passage of the retainer and extending parallel to each other,
the conversion mechanisms include a first conversion mechanism that converts the rotation of the actuator into rotation in the first direction, thereby actuating the fins,
the first conversion mechanism includes:
a rack that extends in an arrangement direction of the fins and is supported to be slidable in the arrangement direction, the rack including teeth arranged next to one another in the arrangement direction; and
multiple pinions that are respectively provided in the fins and mesh with the rack, and
the first conversion mechanism is configured to convert the rotation of the actuator into rotation of the pinions via a linear motion of the rack, thereby rotating the fins in the first direction about the fin pivots.

4. The air-conditioning register according to claim 3, wherein
the retainer includes a through-hole extending from an outer surface to the vent passage,
the movable members include a slide cover, the slide cover being supported to be slidable relative to the retainer in a second direction that differs from the first direction, wherein the slide cover opens and closes the through-hole,
the conversion mechanisms include a second conversion mechanism that converts the rotation of the actuator into a linear motion in the second direction, thereby sliding the slide cover from a closed position, at which the through-hole is closed, to an open position, at which the through-hole is opened, and
the slide cover includes an accommodating portion that accommodates a chemical agent and is continuous with the vent passage through the through-hole when the slide cover is at the open position.

5. The air-conditioning register according to claim 4, wherein
the first conversion mechanism includes an intermittent actuation mechanism,
the intermittent actuation mechanism includes:
a drive source gear that rotates continuously in conjunction with the rotation of the actuator; and
a driven gear that meshes with the drive source gear and the rack to be intermittently actuated by the drive source gear, thereby intermittently converting the rotation of the drive source gear into a linear motion of the rack in the arrangement direction,
the first conversion mechanism is configured to
cause, while the drive source gear rotates from a first phase to a second phase, the drive source gear and the driven gear to mesh with each other, thereby rotating the fins in the first direction, and
prevent, while the drive source gear rotates from the second phase to a third phase on an opposite side from the first phase, the drive source gear and the driven gear from meshing with each other, thereby stopping the rotation of the fins, the second conversion mechanism includes a restriction mechanism, and the restriction mechanism is configured to
restrict a sliding motion of the slide cover from the closed position to the open position while the drive source gear rotates from the first phase to the second phase, and
permit sliding motion of the slide cover from the closed position to the open position while the drive source gear rotates from the second phase to the third phase.

6. The air-conditioning register according to claim 5, wherein
a number of teeth of each pinion is set such that the fins can rotate to a fin-shut position, at which each pair of the fins that are adjacent to each other in the arrangement direction come into contact with each other and overlap with each other, and
the first conversion mechanism is configured to cause, when the drive source gear rotates from the first phase to the second phase in conjunction with the rotation of the actuator, the drive source gear and the driven gear to mesh with each other, thereby rotating the fins from the fin-shut position.

7. The air-conditioning register according to claim 5, wherein the second conversion mechanism is configured to convert the rotation of the actuator to a linear motion in the second direction via rotation of the drive source gear, thereby sliding the slide cover from the closed position to the open position.

8. The air-conditioning register according to claim 3, wherein
the fins are upstream fins,
the fin pivots are first fin pivots,
the movable members include multiple downstream fins,
the downstream fins are disposed in the vent passage on a downstream side of the upstream fins in a flow direction of the air-conditioning air, the downstream fins being rotatable in a second direction about second fin pivots extending in the arrangement direction of the upstream fins, and
the conversion mechanisms include a second conversion mechanism that converts the rotation of the actuator into rotation in the second direction, thereby actuating the downstream fins.

9. The air-conditioning register according to claim 8, wherein
the second conversion mechanism includes an intermittent actuation mechanism,
the intermittent actuation mechanism includes:
a drive source gear that rotates continuously in conjunction with the rotation of the actuator;
an intermediate gear meshed with the drive source gear; and
a driven gear that meshes with the intermediate gear and is actuated intermittently by the drive source gear via the intermediate gear, and
the second conversion mechanism is configured to actuate, each time the intermediate gear is rotated by a prescribed angle, the driven gear intermittently to rotate the downstream fins in the second direction.

10. The air-conditioning register according to claim 9, wherein the first conversion mechanism is configured to convert the rotation of the actuator into a linear motion of the rack in the arrangement direction via rotation of the drive source gear, thereby rotating the upstream fins in the first direction about the respective first fin pivots.

11. The air-conditioning register according to claim 8, wherein
the actuator is configured to rotate in the first direction about an axis parallel to the first fin pivots,
the second conversion mechanism includes a downstream fin actuation mechanism and a rotation plane conversion mechanism,
the downstream fin actuation mechanism includes:
an arm portion supported by the retainer to be rotatable in the second direction;
drive gears that are respectively coupled to ends of the second fin pivots to rotate the downstream fins in the second direction; and
a coupling portion that is provided at a first end in an extending direction of the arm portion and couples the arm portion to the drive gears,
the rotation plane conversion mechanism includes:
a first gear that rotates in the first direction in conjunction with the rotation of the actuator; and
a plate portion that is rotatable in the first direction integrally with the first gear about a rotation axis of the first gear,
an engagement projection is provided at a second end in the extending direction of the arm portion, the engagement projection extending parallel to the second fin pivots, and
the plate portion includes an elongated hole that accommodates the engagement projection and is configured such that, when the plate portion rotates in the first direction in conjunction with rotation of the first gear, the engagement projection slides in the elongated hole, so that the downstream fin actuation mechanism rotates in the second direction.

12. The air-conditioning register according to claim 1, wherein
the retainer includes a through-hole extending from an outer surface to the vent passage,
the movable members include a slide cover, the slide cover being supported to be slidable relative to the retainer in a first direction, wherein the slide cover opens and closes the through-hole,
the conversion mechanisms include a first conversion mechanism that converts the rotation of the actuator into a linear motion in the first direction, thereby sliding the slide cover from a closed position, at which the through-hole is closed, to an open position, at which the through-hole is opened, and
the slide cover includes an accommodating portion that accommodates a chemical agent and is continuous with the vent passage through the through-hole when the slide cover is at the open position.
